(19) United States
(12) Patent Application Publication
(10) Pub. No.: US 2022/0318866 A1
(43) Pub. Date: Oct. 6, 2022

(54) PAYMENT SYSTEM AND METHOD

(71) Applicant: Scott Orlinsky, Aventura, FL (US)

(72) Inventor: Scott Orlinsky, Aventura, FL (US)

(21) Appl. No.: 17/713,342

(22) Filed: Apr. 5, 2022

Related U.S. Application Data
(60) Provisional application No. 63/171,063, filed on Apr. 5, 2021.

(51) Int. Cl. G06Q 30/04; G06Q 20/32; G06Q 20/40; G06Q 20/20

(52) U.S. Cl. CPC G06Q 30/04; G06Q 20/3221; G06Q 20/4014; G06Q 20/3255; G06Q 20/20

(57) ABSTRACT

The present invention is a payment system and method, which provides a solution to the problem of providing secure and contactless payments. The core components of the invention are a server or other hardware system that communicates with point of sale terminals or other vendor hardware, user devices, and bank servers to generate invoices, communicate invoices to users, authorize payments with the user and the user's bank, and send confirmation messages.

### CROSS REFERENCE TO RELATED APPLICATIONS

This application claims priority to U.S. Provisional Patent No. 63/171,063 filed on Apr. 5, 2021.

### BACKGROUND

Different systems and methods for providing payment electronically have been implemented. Most methods involve a user providing a credit/debit card number, either using a magnetic strip on a physical card or entering the number into a system. Other methods include using near field communication between an electronic device (such as a mobile phone) and a point of sale (POS) terminal.

These systems have several problems including sanitary and security problems. Customers at stores are often asked to input information into a POS terminal and slide their card through a card reader on the POS terminal. The POS terminal quickly can become contaminated with pathogens from the hands of the various users using the device.

Further, criminals are known to place card readers on POS terminals which collect credit card information. These card readers are often designed to be difficult to see and can allow a criminal to use the gathered information to commit fraudulent purchases.

Mobile phone applications which communicate using near field communication are more secure than physical credit cards but are still vulnerable to various types of attacks such as “wormhole” attacks where the near field communication is intercepted (eavesdropped) in real time and communicated to a second device that uses the intercepted information to perform a fraudulent transaction.

Further, near field communication generally requires the mobile device to be so close to the reader that contact is inevitable and the sanitation concerns of credit cards also exist with near field communication.

### SUMMARY

The disclosed system is unique when compared with other known devices and solutions because it provides a contactless and secure method of processing payments. Users may provide an identification such as the user's phone number to a vendor. The vendor may enter the identification into the point of sale (POS) terminal and the user will then receive a text message with a link to a secure platform for paying the invoice, the link can then be used by the user and the payment processed securely without any contact between the user and POS terminal or the vendor.

The system may operate by receiving the user's identification and invoice information from a vendor device (such as a POS terminal). An invoice may be generated on the secure payment platform and a link to the invoice may be sent via text message to a mobile device associated with the user. When the user uses the link, the system may receive a request to provide the linked information to the user. The link may open a web page or an application on the user's mobile device. The system may receive the user's authorization to pay the invoice and banking information. The system may then contact the bank to authorize the transaction. After the bank has authorized the transaction the system may send confirmation messages to the user's mobile device and the vendor device

### BRIEF DESCRIPTION OF DRAWINGS

FIG. 1A shows an example schematic view of a vendor device.

FIG. 1B shows an example schematic view of a service device.

FIG. 1C shows an example schematic view of a mobile device.

FIG. 1D shows an example schematic view of a bank device.

FIG. 2 shows an example schematic view of a service system.

FIG. 3 is a diagram of communications between devices in the service system.

FIG. 4 is a flow diagram of operations performed by the service device.

FIG. 5 shows an example text message communication.

FIG. 6 shows an illustrative flow for payment system and method.

FIG. 7 continues the illustrative flow showing the phone number and device being provisioned with a Network Token to be used for future payment.

FIG. 8 continues the illustrative flow for payment system and method.

FIG. 9 continues the illustrative flow for payment system and method.

### DETAILED DESCRIPTION

In the Summary above, in this Detailed Description, the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range including that number (which may be a range having an upper limit or no upper limit, depending on the variable being defined). For example, “at least 1” means 1 or more than 1. The term “at most” followed by a number is used herein to denote the end of a range, including that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limits include both numbers. For example, “25 to 100” means a range whose lower limit is 25 and upper limit is 100 and includes both 25 and 100.

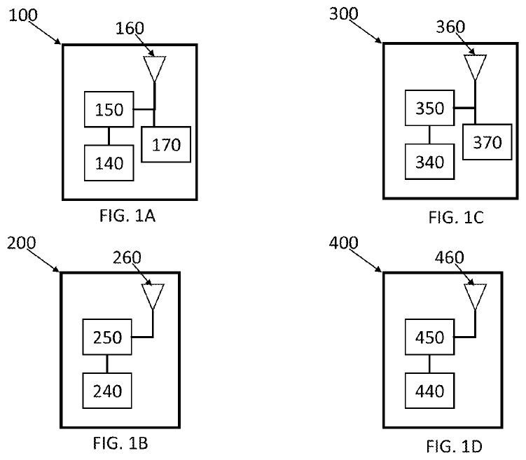

FIG. 1A shows an example schematic view of a vendor device 100. The vendor device 100 may include one or more memories 140, one or more processors 150, one or more communication hardware 160, and one or more displays 170. The memory 140 may include volatile and non-volatile memory and may include instructions for operating the vendor device 100. The processor 150 may be a central computing unit or other form of processing hardware capable of executing the instructions for operating the vendor device 100. The processor 150 may control the vendor device 100. The communication hardware 160 may include ports for wired communication, hardware for wireless local area network communications, and hardware for other types of wireless communications such as 4G LTE, 5G, etc. The display 170 may include a touch screen display, liquid crystal display, plasma display, or other form of display hardware capable of displaying information to a person.

The vendor device 100 may be a point of sale (POS) terminal, computer, tablet, mobile device, or other device capable of generating a sales invoice and communicating with other electronic devices.

FIG. 1B shows an example schematic view of a service device 200. The service device 200 may include one or more memories 240, one or more processors 250, and one or more communication hardware 260. The memory 240 may include volatile and non-volatile memory and may include instructions for operating the service device 200. The processor 250 may be a central computing unit or other form of processing hardware capable of executing the instructions for operating the service device 200. The processor 250 may control the service device 200. The communication hardware 260 may include ports for wired communication, hardware for wireless local area network communications, and hardware for other types of wireless communications such as 4G LTE, 5G, etc.

The service device 200 may be one or more servers, computers, or other electronic devices capable of communicating with other electronic devices and performing the functions detailed below.

FIG. 1C shows an example schematic view of a mobile device 300. The mobile device 300 may include one or more memories 340, one or more processors 350, one or more communication hardware 360 and one or more displays 370. The memory 340 may include volatile and non-volatile memory and may include instructions for operating the mobile device 300. The processor 350 may be a central computing unit or other form of processing hardware capable of executing the instruction for operating the mobile device 300. The processor 350 may control the mobile device 300. The communication hardware 360 may include ports for wired communication, hardware for wireless local area network communications, and hardware for other types of wireless communications such as 4G LTE, 5G, etc. The display 370 may include a touch screen display, liquid crystal display, plasma display, or other form of display hardware capable of displaying information to a person.

The mobile device 300 may be a smart phone, tablet, computer, or other device capable of communicating with other electronic devices.

FIG. 1D shows an example schematic view of a bank device 400. The bank device 400 may include one or more memories 440, one or more processors 450, and one or more communication hardware 460. The memory 440 may include volatile and non-volatile memory and may include instructions for operating the bank device 400. The processor 450 may be a central computing unit or other form of processing hardware capable of executing the instruction for operating the bank device 400. The processor 450 may control the bank device 400. The communication hardware 460 may include ports for wired communication, hardware for wireless local area network communications, and hardware for other types of wireless communications such as 4G LTE, 5G, etc.

The bank device 400 may be one or more servers, computers, or other devices capable of communicating with other electronic devices.

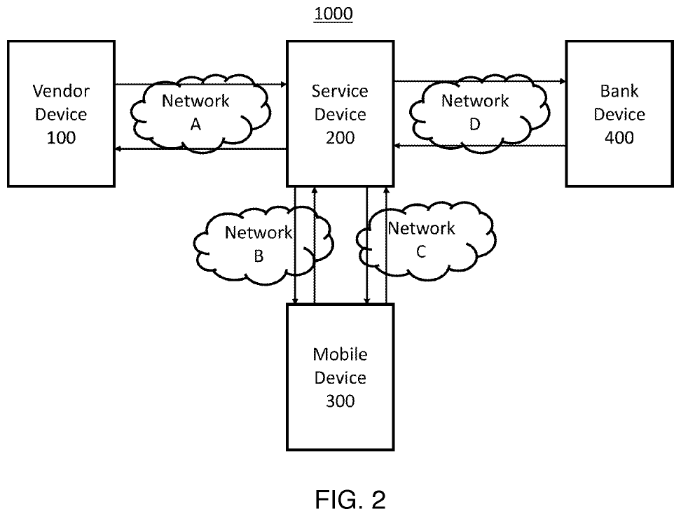

FIG. 2 shows an example schematic view of a service system 1000. The service device 200 may communicate with the vendor device 100 via network A. The service device 200 may communicate with the mobile device 300 via networks B and C. The service device may communicate with the bank device 400 via network D. Network A may be a wired or wireless network or a combination of networks. For example, Network A may be an internet connection between the vendor device 100 and the service device 200. As another example, the network A may be a mobile network. Network B may be a mobile network with communications sent over short message service (SMS) or multimedia messaging service (MMS). Network C may be a wireless network for communicating via the internet such as a wireless local area network or data service of a mobile network. Network D may include wired and/or wireless networks for communicating via the internet. For example, Network D may include a wired internet connection, or wireless internet connection.

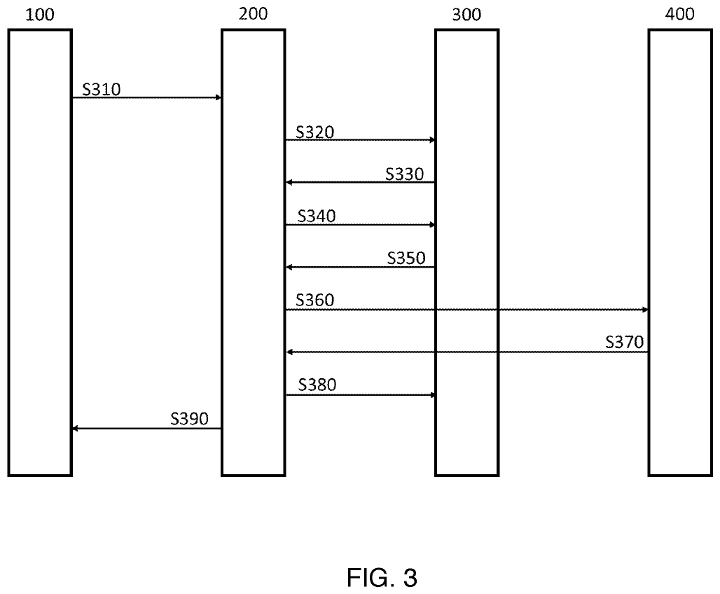

FIG. 3 is a diagram of communications between devices in the service system 1000. At S310, the vendor device 100 may transmit and the service device 200 may receive (over network A) invoice information and user identification information to service device 200. The invoice information may be information regarding a sale of merchandise or services by the vendor to the user. The user identification information may be a number that identifies the user; for example, a phone number or other unique identifying number. In some embodiments, vendor device 100 may have an NFC chip read whereby mobile device 300 may transmit the phone number of mobile device 300 automatically or manually.

At S320, the service device 200 may transmit and the mobile device 300 may receive (over network B) a service message via SMS messaging or MMS messaging (i.e., text messaging) including a link to a secure communication platform. The service message may also include information about an invoice including a total, a vendor from which the invoice originated, and time of invoice. An example service message may read “Please open the link below to pay the $98.65 invoice for sale at Joe's Hardware at 11:15 AM” followed by a hyperlink. The service device 200 may transmit the service message to the mobile device 300 associated with the user identification received from the vendor device 100.

At S330, the mobile device (by the user opening the hyperlink included in the service message) may request secure communications (over network C) related to the service message. At S340, the service device 200 may transmit an invoice to the mobile device 300 (over network C) via the secure website or mobile application hosted by the service device 200. The invoice may include an itemized list of services and merchandise that is being purchased as well as a total, a vendor identification, a time of invoice, as well as other information related to the purchase. The website or mobile application may display the invoice and also include several features including: a tool or button for a user to select to authorize payment of the invoice; a tool or button for a user to select to decline payment of the invoice; and tools or an area for payment information (such as debit/credit card number, bank account information, etc.) to be entered or selected. For example, the user may open the link and be provided with an invoice. The user may then select a payment method from a list of previously entered payment methods or enter a new payment method and select to authorize payment using the selected payment method. If no valid payment methods are available the website or mobile application may prompt the user to enter a payment method.

At S350, the mobile device may transmit and the service device 200 may receive (over network C) an invoice response including confirmation information and/or payment information. The confirmation information may include authorization of payment or declining payment for the invoice. The payment information may include a selection of a previously entered payment method or new payment method. If the confirmation information includes declining payment, the service device 200 may proceed to operation S380.

If the invoice response includes authorization to pay the invoice, at S360 the service device 200 may send and the bank device 400 may receive (over network D) fund transfer information based on the payment information and invoice. The fund transfer information may include information required by the bank to complete a transfer of funds including name of parties (vendor and user), account or card information (payment information), etc. The bank device 400 may then process the fund transfer information and either approve or decline the fund transfer.

At S370, the bank device 400 may transmit and the service device 200 may receive (over network D) a fund transfer response. The Fund transfer response may include an indication of acceptance of transfer of funds or a rejection of transfer of funds.

At S380, the service device 200 may send and the mobile device 300 may receive (over network C) a first transaction message. The first transaction message may include confirmation of successful transaction (indicating the bank accepted transfer of funds) or rejected transaction (indicating the bank did not accept transfer of funds). If the transfer of funds is rejected, the user on the mobile device may do many things which are not shown in FIG. 3. For example, the user may select or enter a different payment method and return to S350, the user may decline to pay the invoice and return to S350. Otherwise, the service device 200 may continue to S390.

At S390, the service device 200 may send and the vendor device 100 may receive (over network A) a second transaction message. The second transaction message may include confirmation of successful transaction (indicating the bank accepted transfer of funds) or rejected transaction (indicating the bank did not accept transfer of funds or user declining to pay the invoice).

Accordingly, a service device 200 may communicate with a vendor device 100, mobile device 300, and a bank device 400 in order to complete a transaction securely and without contact. Further, the service device 200 may communicate with the mobile device 300 over Network B or/and Network C while completing the transaction.

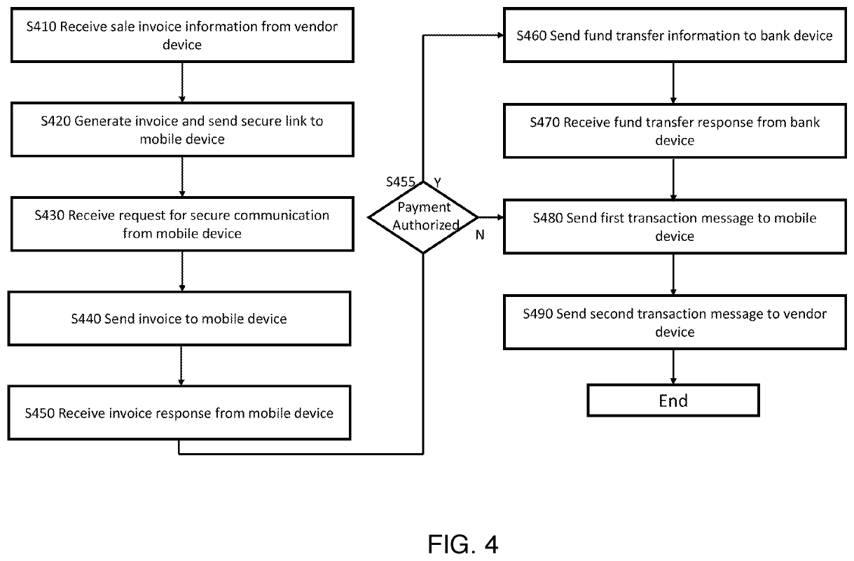

FIG. 4 is a flow diagram of operations performed by the service device 200. At S410, the service device 200 may receive sale invoice information from the vendor device 100 over the network A. The sale invoice information may include a user identification, sale data, and any other data required to complete a transaction. The sale data may include a total monetary amount of the transaction, a list of services and merchandise, itemized prices for services and merchandise, etc. The user identification may be a phone number associated with the user's mobile device 300, an identification, or any other identifier that uniquely identifies a user.

At S420, the service device 200 may generate an invoice based on the invoice information. For example, the service device 200 may identify a user, a user account, or a user device based on the user identification. The service device 200 may generate the invoice with information regarding the transaction, including the sales data, user account information, vendor data, time invoice was generated, time sale invoice information was received from the vendor, etc. The invoice may be generated at a webpage, may be added to a webpage, may be generated as information accessible in a mobile application, or in another manner that can be securely accessed using a mobile device such as the mobile device 300.

Further, at S420, once the invoice is generated, the service device 200 may send a secure link to the mobile device 300 associated with the user identification number. The secure link may be a hyperlink to a webpage, a link to a mobile application, or other way of securely accessing the invoice. The secure link when opened may cause the mobile device to open (or request information to open) a mobile application or web page (or other secure method for accessing information) which includes the invoice.

At S430, the service device 200 may receive a request for secure communication from the mobile device. The request for secure communication may be sent from the mobile device 300 by opening the secure link sent at S420. The service device 200 may host the website or mobile application used by the mobile device 300 and opened by the secure link. Accordingly, the service device 200 may receive a request for secure communication when the user opens the secure link sent to the mobile device 300.

At S440, in response to the request for secure communication, the service device 200 may send the invoice to the mobile device 300. This may be accomplished by providing information to the mobile device 300 to open the direct payment webpage or open the direct payment mobile application. Alternatively, the invoice may be automatically sent to the mobile application and the invoice may be sent independently of the secure link being opened.

At S450, the service device 200 may receive an invoice response from the mobile device 300. The invoice response may include an indication of payment authorization (approval or rejection) as well as payment information. The payment information may include a bank or other financial institution's name from which the transfer of funds will be made and credit/debit card numbers, account numbers, routing numbers, etc. If payment is to be made through a method that has previously been used, approval of the invoice may act as payment information for payment to be made by the same method as previously used. As a further example, if payment has previously been made using a method, payment information may include an indication that the last method is to be used again. Accordingly, the payment information may be any indication of payment method.

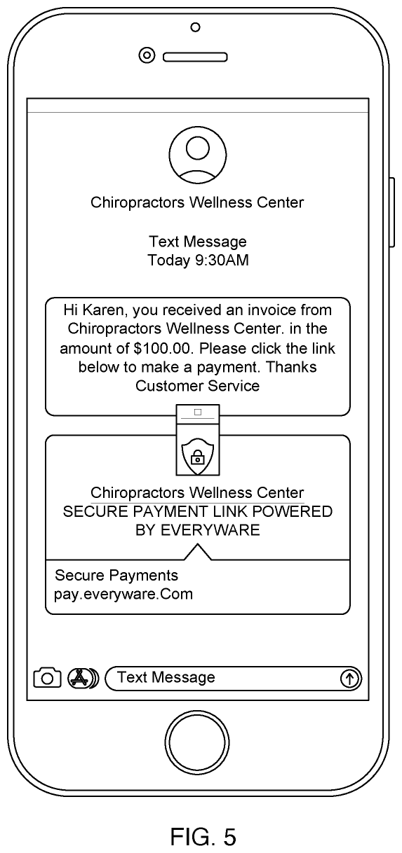

In one or more embodiments, payment information may be stored in one or more databases whereby the next time the user receives an approval request for a transaction a text message or other display may be shown to user as illustrated in FIG. 5. The text message may display the vendor or service provider as well as the sales information and a request for the user to approve the transaction such that the user may respond yes to approve the transaction whereby the service device 200 may proceed to S460 thus skipping the need for the user selecting the link and viewing the invoice.

At S455, the service device 200 may determine if the payment authorization authorizes payment (e.g., includes approval). If payment is authorized, the service device 200 may proceed to S460. If payment is not authorized (e.g., the payment authorization includes a rejection), then the service device 200 may proceed to S480.

At S460, the service device 200 may send fund transfer information to a bank device 400. The bank device 400 may be associated with the payment method the user indicated is to be used to pay the invoice. The bank device 400 may be operated by a bank, credit union, credit card company, or other financial institution or intermediary. The fund transfer information may include the amount to be paid/transferred, user account or credit/debit card number, vendor name, as well as any other information required to complete the transaction to pay the invoice. Restated, the service device 200 may communicate with bank server 400 to authorize payment of the invoice.

At S470, the service device 200 may receive a fund transfer response from the bank device 400. The fund transfer response may include approval of fund transfer or rejection of fund transfer. A fund transfer response including rejection of fund transfer may also include a reason for rejecting fund transfer. If fund transfer is rejected then various steps may be taken to remedy the situation (not shown), such as sending a message to the mobile device 300 and requesting a different payment method for completing the transaction and returning to S450 to await new payment information or for the user to decline to pay the invoice. Alternatively, the service device 200 may proceed to S480. If the fund transfer response includes approval of the fund transfer, the service device 200 may proceed to S480.

At S480, the service device 200 may send a first transaction message to the mobile device 300. The first transaction message may include a message indicating approval of transfer of funds such as “invoice paid,” “transfer approved,” etc. The first transaction message may also include a message indicating the invoice was not paid, including “transaction declined,” “invoice not paid,” etc. The first transaction message may include the message indicating approval of transfer of funds in response to the fund transfer response indicating that the transaction was approved. The first transaction message may include the message indicating the invoice was not paid if payment of the invoice was not authorized or if the fund transfer response indicates the transaction was declined.

At S490, the service device 200 may send a second transaction message to the vendor device 100. The second transaction message may include a message indicating approval of transfer of funds such as “invoice paid,” “transfer approved,” etc. The second transaction message may also include a message indicating the invoice was not paid, including “transaction declined,” “invoice not paid,” etc. The second transaction message may include the message indicating approval of transfer of funds in response to the fund transfer response indicating that the transaction was approved. The second transaction message may include the message indicating the invoice was not paid if payment of the invoice was not authorized or if the fund transfer response indicates the transaction was declined. The second transaction message may be different from the first transaction message.

Advantageously, the service device 200 may facilitate payment of an invoice without a user having to touch the vendor device 100. Further, the transaction is accomplished in a secure method (by having the user device receive a secure link in a text message and complete the transaction via a secure website or mobile application) that is not vulnerable to the attacks used against other payment methods.

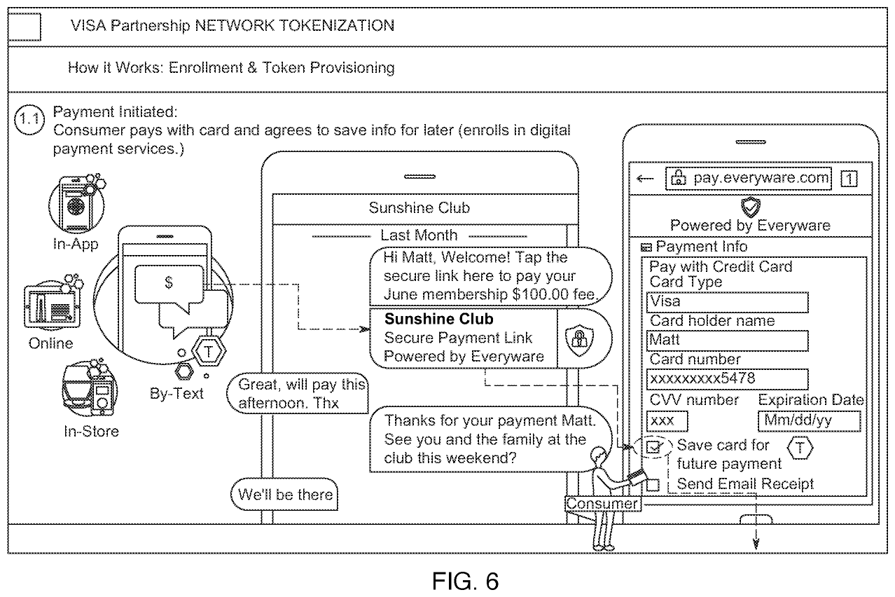

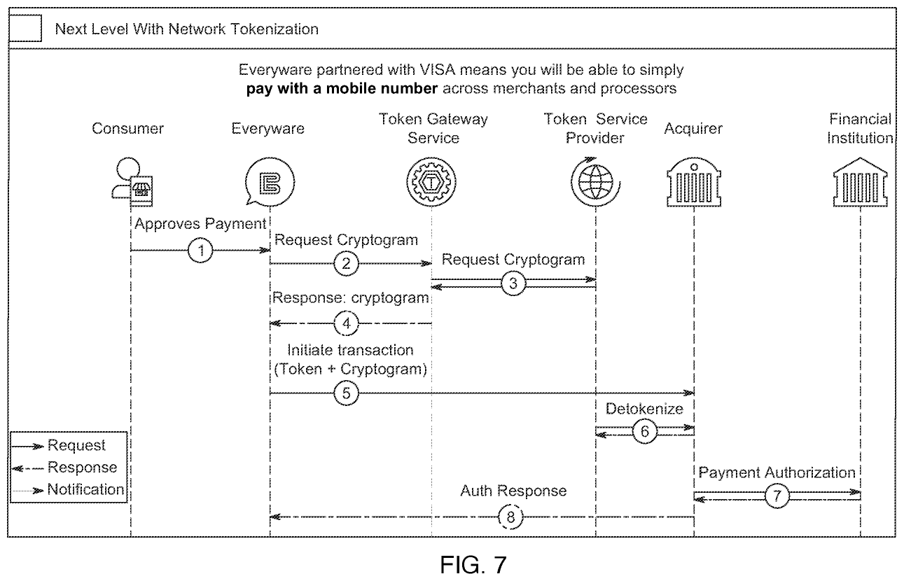

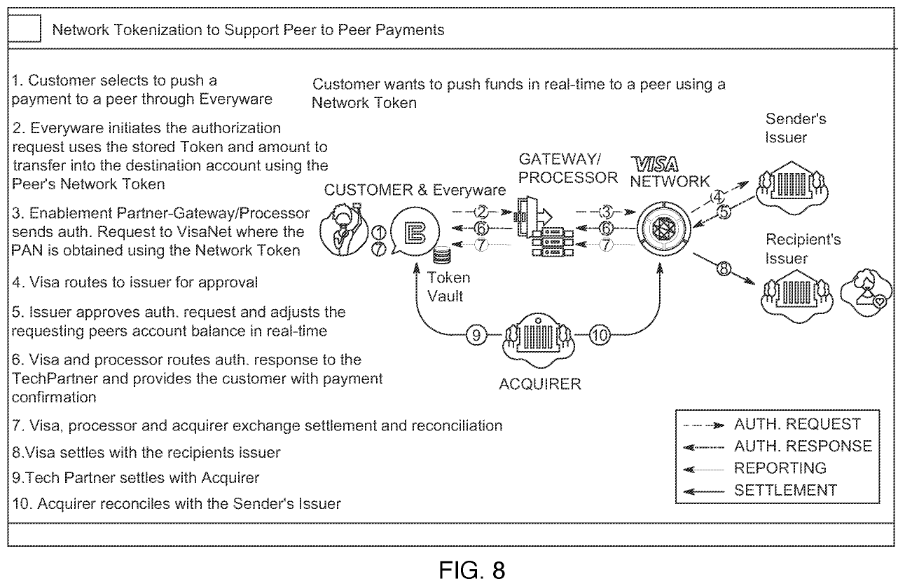

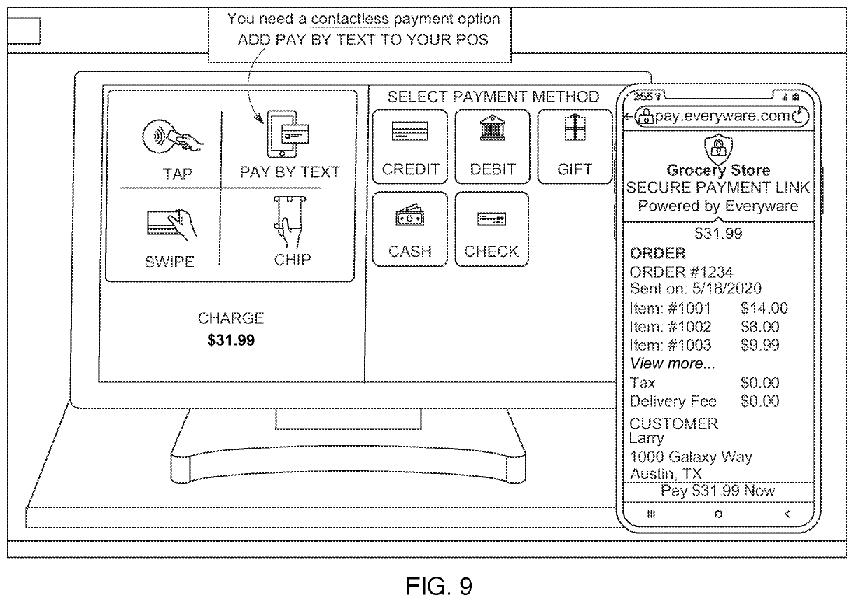

In one or more non-limiting embodiments service device 200 may have implemented API that works across all major payment processors such as VISA® whereby users may pay over multiple businesses and companies as illustrated in FIG. 6-9.

In this embodiment the mobile device may select an option to pay through the Everyware API and transmit and Everyware may receive (over network C) an invoice response including confirmation information and/or payment information. The confirmation information may include authorization of payment or declining payment for the invoice. The payment information may include a selection of a previously entered payment method or new payment method. Everyware then initiates the authorization request using a stored network token and amount to transfer into the destination account using the peer's network token. An enablement partner-gateway/processor then sends authorization request to VisaNet where the PAN is obtained using the Network Token. Visa then routes to the issuer for approval. The Issuer then approves authorization request and adjusts the requesting peers account balance in real-time. Visa and the processor routes authorization response to the Tech partner and provides the mobile device with payment confirmation. Visa, the processor and acquirer exchange settlement and reconciliation. Visa then settles with the recipients issuer. Tech Partner then settles with Acquirer. Acquirer then reconciles with the Sender's Issuer.

Accordingly, the present description provides for various embodiments for a service device 200 for facilitating secure payments. Many uses and advantages are offered by the service device 200 as described above in one or more non-limiting embodiments in the present description.

The corresponding structures, materials, acts, and equivalents of any means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention, according to one or more embodiments described in the present description, may be practiced with modification and alteration within the spirit and scope of the appended claims. Thus, the description is to be regarded as illustrative instead of restrictive of the present invention.

What is claimed is:

1. A payment system comprising:
a service device having a memory including a plurality of processor readable instructions for operating the service device, and a processor configured to execute the plurality of processor readable instructions to:
generate an invoice based on communications with a vendor device;
receive payment information from a mobile device based on first communications over a first network and second communications over a second network, wherein the payment information includes approval to pay the invoice; and
communicate with a bank server to authorize payment of the invoice.

2. The payment system of claim 1, wherein the processor is further configured to execute the plurality of processor readable instructions to:
communicate confirmation of authorization of the payment of the invoice to the vendor device and the mobile device.

3. The payment system of claim 1, wherein the first communications include a text message sent from the service device to the mobile device, the text message including a link to the invoice.

4. The payment system of claim 1, wherein the service device is a point of sale terminal.

5. The payment system of claim 1, wherein the service device is a tablet or second mobile device.

6. A payment system comprising:
a service device having memory including a plurality of processor readable instructions for operating the service device and a processor configured to execute the plurality of processor readable instructions to:
receive sales invoice information from a vendor device;
generate an invoice based on the sales invoice information;
send a secure link to a mobile device;
receive a request for secure communication from the mobile device;
send the invoice to the mobile device based on the request for the secure communication;
receive an invoice response from the mobile device;
send fund transfer information to a bank device based on the invoice response; and
receive fund transfer response from the bank device.

7. The payment system of claim 6, wherein the processor is further configured to execute the plurality of processor readable instructions to:
communicate confirmation of authorization of payment of the invoice to the vendor device and the mobile device.

8. The payment system of claim 6, wherein the processor is further configured to execute the plurality of processor readable instructions to: sending a text message from the service device to the mobile device, the text message including a link to the invoice.

9. The payment system of claim 6, wherein the service device is a point of sale terminal.

10. The payment system of claim 6, wherein the service device is a tablet or second mobile device.

11. A payment system comprising:
a computing system having a non-transitory computer-readable medium comprising code, the computing system having one or more processors coupled to one or more databases over a network, wherein instructions are executed by the computing system to perform:
receiving a phone number for a user computing device;
sending a request to approve a transaction to the user computing device;
receiving an approval response from the user computing device;
sending fund transfer information to a bank device based on the approval response; and
receiving fund transfer response from the bank device.

12. The payment system of claim 11, wherein the instructions are executed by the computing system to further perform:
receiving one or more payment methods from the user computing device; and
storing one or payment methods on the one or more databases.

13. The payment system of claim 12, wherein the instructions are executed by the computing system to further perform:
retrieving the one or more payment methods stored from the user computing device;
displaying the request to approve the transaction to the user computing device with an identifier of the one or more payment methods stored from the user computing device; and
and in response to only a single action being performed on the user computing device, the approval response is transmittable.

14. The payment system of claim 13, wherein the request is displayed as a text message.

15. The payment system of claim 14, wherein the text message includes a name of a service provider.

16. The payment system of claim 15 wherein the single action is sending of a second text message.

17. The payment system of claim 14, wherein the request to approve includes a secure link to an invoice.

18. The payment system of claim 17, wherein the instructions are executed by the computing system to further perform:
receiving a request for secure communication from the user computing device.

19. The payment system of claim 11, wherein the phone number is received by a point of sale terminal.

20. The payment system of claim 11, wherein the payment system implemented API that works across one or more payment processors wherein the one or more payment processors routes an authorization response to a tech partner and provides the user computing device with payment confirmation
